(19) United States
(12) Patent Application Publication
(10) Pub. No.: US 2013/0055792 A1
(43) Pub. Date: Mar. 7, 2013

(54) HYGIENIC INTEGRITY TEST IN ULTRAFILTRATION SYSTEMS

(71) Applicants: Dirk Scheu, Amerdingen (DE); Joerg Zacharias, Koefering (DE)

(72) Inventors: Dirk Scheu, Amerdingen (DE); Joerg Zacharias, Koefering (DE)

(73) Assignee: KRONES AG, Neutraubling (DE)

(21) Appl. No.: 13/604,837

(22) Filed: Sep. 6, 2012

(30) Foreign Application Priority Data
Sep. 7, 2011 (DE) 10 2011 082 284.4

(51) Int. Cl. G01M 3/02

(52) U.S. Cl. 73/37

(57) ABSTRACT

A method for testing the integrity of a hollow fibre membrane includes inserting a sterile, monomolecular gas into an interior of the hollow fibre membrane, applying a starting gas pressure on the gas in the interior of the hollow fibre membrane at a first point in time, and measuring the pressure of the gas at a second point in time after the first point in time so as to determine a final gas pressure.

### CROSS REFERENCE TO RELATED APPLICATIONS

This application claims priority to German Patent Application No. DE 10 2011 082 284.4, filed Sep. 7, 2011, which is hereby incorporated by reference herein in its entirety.

### FIELD

The present invention relates to a method for testing the integrity of a hollow fibre membrane.

### BACKGROUND

In order to test the functionality of the hollow fibres frequently deployed for ultrafiltration, a so-called integrity test can be conducted. The hollow fibre membrane is thereby emptied by being pressed with air so that, for example, permeate located in the membrane is pressed through the pores of the hollow fibre membranes and onto the non-filtrate side. The air is then acted upon with positive pressure of, for example, 1 bar. Because the air cannot penetrate through the membranes at this pressure, the existing air pressure must remain constant for several minutes and not drop.

This test is modelled on the so-called bubble point test in which the membrane housing is, e.g., pressurised slowly from the permeate side, in order to force the water out of the pores. If the pressure on the permeate side of the filter is increased further, air bubbles appear on the non-filtrate side if the pressurisation is sufficient. The pressure difference needed for this is given by the quadruple of the surface tension of the fluid, meaning, for example, of the water, multiplied by the cosine of the wetting angle of contact and divided by the pore diameter.

If the pressure difference during the integrity test lies below the bubble pressure, the applied pressure should be held for a certain time, because no bubbles can escape in this case and with intact membranes. This is then taken as proof that the membranes are in order and there is no so-called fibre breakage and/or leakage.

It is thereby detrimental, however, that when compressed ambient air is utilised as the fluid for pressurisation, there is a risk that impurities, particularly airborne germs, are inserted into the hollow fibre membranes. Although it is possible to improve this situation by using so-called sterile air, ensuring the purity of such air during the manufacture can be guaranteed only with very complex arrangements.

### SUMMARY

In an embodiment, the present invention provides a method for testing the integrity of a hollow fibre membrane includes inserting a sterile, monomolecular gas into an interior of the hollow fibre membrane, applying a starting gas pressure on the gas in the interior of the hollow fibre membrane at a first point in time, and measuring the pressure of the gas at a second point in time after the first point in time so as to determine a final gas pressure.

### BRIEF DESCRIPTION OF THE DRAWING

Further characteristics, further exemplary embodiments and advantages of the present invention are explained in more detail in the following with reference to the drawing. It shall be understood that the embodiments do not exhaust the range of the present invention. It shall furthermore be understood that some or all of the features described in the following can also be combined with one another in other ways.

FIG. 1 illustrates an embodiment of the method according to the invention.

### DETAILED DESCRIPTION

In an embodiment, the present invention provides a method with which an efficient hygienic test can be conducted for defective or damaged membranes.

In an embodiment, the present invention provides a method for testing the integrity of hollow fibre membranes having the following steps: Insertion of a sterile monomolecular gas into an interior of the hollow fibre membrane; application of a starting gas pressure on the sterile monomolecular gas in the interior of the hollow fibre membrane at a first point in time; and measurement of the pressure of the sterile monomolecular gas at a second point in time after the first point in time in order to determine a final gas pressure.

The insertion of a sterile gas into the interior of the hollow fibre membrane has the advantage that as a result of this, no germs can reach the hollow fibre membrane and consequently the permeate or filtrate.

The application of the gas at a starting gas pressure in the interior of the hollow fibre membrane at a first point in time and the measurement of the pressure of the sterile gas at a second point in time after the first point in time in order to determine a final gas pressure furthermore has the advantage that only one pressure measurer is required and the method according to the invention can run in a largely automated manner, while in the case of the bubble point test it is necessary to measure on two sides of the membrane and furthermore there must be an observation, for example, by operating personnel, in order to determine the point in time at which bubble formation occurs.

The utilisation of a monomolecular gas, meaning a pure gas, meaning not a gas mixture but rather a gas with a stipulated molecular composition and a single specific molar mass, has the advantage that the sensitivity of the test is improved because the separation limit of the membrane with regard to the permeability depends on the specific molar mass of the gas. For example, in the case of a gas mixture such as in the state of the art, it can happen that constituents with a certain molar mass already escape through the pores while gas constituents with a different specific molar mass require a higher pressure before they escape. This results in a blurring of the necessary pressure difference at which bubble formation takes place in the bubble point test. Due to the specifically selected pure gas, the separation limit is sharper than with a gas mixture, such as air.

The method according to embodiments of the invention can be further developed by providing the following additional steps, namely the assessment of the hollow fibre membrane as free of defects if the final gas pressure deviates from the starting gas pressure by a value that is less than a predetermined differential pressure, and the assessment of the hollow fibre membrane as defective if the final gas pressure deviates from the starting gas pressure by a value that is equal to or greater than the predetermined differential pressure. By making the assessment of the hollow fibre membrane as free of defects or defective by means of the difference in the pressure at the beginning and at the end of the test, a threshold value in the form of the predetermined differential pressure can be specified from which the hollow fibre membrane is considered to be defective. This has the advantage that any slow pressure drop that there may be, e.g., due to cooling effects of the sterile gas or due to a few larger pores in the membrane, can be included in the assessment.

According to another further development of the method according to the invention, the second point in time can be a predetermined length of time after the first point in time. In this way, a test duration is stipulated with which a reliable assessment of the hollow fibre membrane can be made, or whereby any transient processes that there may be have abated.

The step of the insertion of the sterile gas into the interior of the hollow fibre membrane can comprise an extrusion of fluid from the hollow fibre membrane. In this way, a fluid volume existing within the hollow fibre membrane from the filtration process is already pressed out with the sterile gas, whereupon the integrity test can then follow immediately.

The method can be improved to the effect that the starting gas pressure is less than a gas bubble pressure. The gas bubble pressure is defined such that a gas bubble escape would take place in the case of rising pressure at the gas bubble pressure and above the gas bubble pressure, namely through the pores of a membrane without defects. By selecting the starting gas pressure such that it is less than the gas bubble pressure, no gas bubbles emerge, and the test of the membranes takes place via the constancy of the pressure (within a certain range).

According to another further development, the sterile gas can be free of oxygen, nitrogen and hydrogen. This particularly serves to prevent any germs that there may be that can utilize oxygen, nitrogen or hydrogen from being kept alive.

According to another further development, the sterile monomolecular gas can be carbon dioxide. In the case of the particularly preferred carbon dioxide, its molar mass of 44 g/mol means that the specific gaseous density for the same volume is greater than that of air, as a result of which the bubble point pressure or gas bubble pressure drops. The integrity test can consequently reliably be conducted at pressures less than 0.5 bar. In this way, the constructional system, namely, the membrane module, no longer falls under the limiting values of the Druckbehälterverordnung [German pressure vessel ordinance]. It shall be understood that the gas should exist in a gaseous form, not in a dissolved form. A further advantage of the utilisation of carbon dioxide lies in the fact that the CO2 has a disinfecting effect on the membrane. A further advantage is that, for example, in the application of the method according to the invention in the drink industry, carbon dioxide is already available on a large scale.

According to a further development, the hollow fibre membranes for which this test method is applied are suitable for ultrafiltration, whereby particles in the size from 0.1 to 0.01 μm can be filtered out.

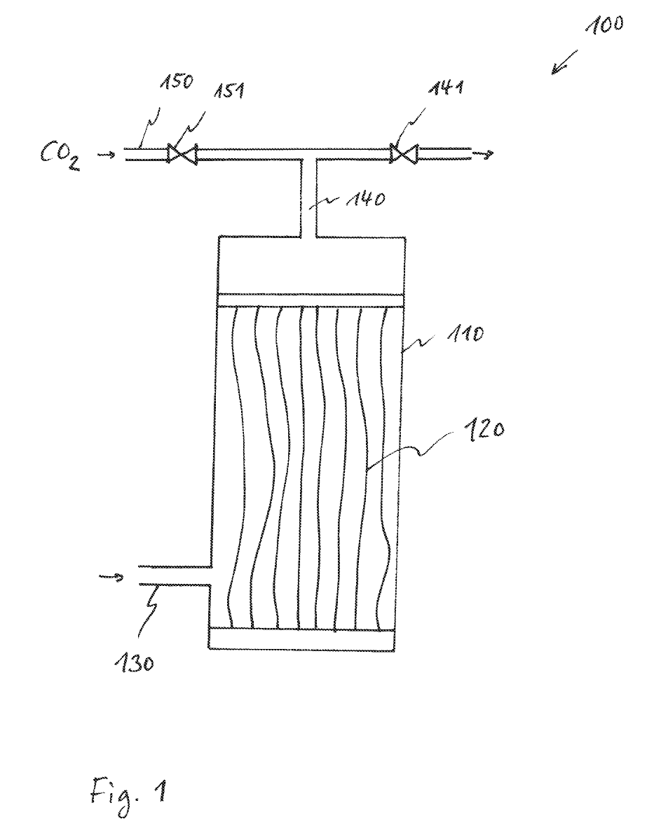

FIG. 1 illustrates an embodiment of the method according to the invention in conjunction with a filter module 100. The filter module 100 comprises a housing 110 with hollow fibre membranes 120, which are suitable for ultrafiltration such as is customary in the beverage industry, for example. Unfiltered water, meaning untreated water, is fed in via an inlet 130. This untreated water is filtered through a negative pressure existing on the inner side of the hollow fibre membrane and leaves the housing 110 via a line 140 as permeate, meaning as filtered water. The module 100 furthermore comprises a permeate valve 141 in the permeate line 140. The permeate line 140 is moreover coupled to a gas line 150 via a gas valve 151.

The filtration of water with the filter of the module, which contains hollow fibre membranes, is stopped in order to conduct the integrity test. The valve 141 is closed for this purpose. Then the gas valve 151 is opened, and carbon dioxide is pressed in via the permeate line in the reversed direction (with respect to the filtration direction), as a result of which permeate is pressed through the membranes 120 on to the non-filtrate side in the reversed direction. When the hollow fibre membranes 120 have been pressed empty, the pressure of the CO2 gas is increased even further, but it remains below the bubble point at which the CO2 bubbles would escape through the pores of the membranes 120. The pressure is measured at the beginning and end of the test and a differential pressure is determined from the starting pressure and the final pressure. If this difference exceeds a certain threshold, it is assumed that a breakage or other leak has occurred in one or more of the hollow fibres. Such a leak leads to an escape of the gas and consequently to a pressure drop across the time period of the measurement. In this embodiment with CO2 as the gas, the starting pressure is adjusted at approximately 0.5 bar. If this pressure has fallen by, for example, 10% after several minutes, it can be assumed that there is a defective position in one or more of the hollow fibre membranes 120.

Due to the utilisation of CO2 as the only gas, it is possible to achieve good selectivity for the determination of fibre breaks. In contrast to this, for example, the customarily utilised air is a gas mixture with approximately 78% nitrogen having a molar mass of 28 g/mol and 21% oxygen having 32 g/mol, along with low levels of other gases. The different molar mass leads to different escape behaviour, because the partial pressures of the constituents are different. With CO2 and its molar mass of 44 g/mol, only one (partial) pressure is present and crucial for the bubble point.

While the invention has been particularly shown and described with reference to preferred embodiments thereof, it will be understood by those skilled in the art that various changes in form and details may be made therein without departing from the spirit and scope of the invention.

What is claimed is:

1. A method for testing the integrity of a hollow fibre membrane, the method comprising:
inserting a sterile, monomolecular gas into an interior of the hollow fibre membrane;
applying a starting gas pressure on the gas in the interior of the hollow fibre membrane at a first point in time; and
measuring the pressure of the gas at a second point in time after the first point in time so as to determine a final gas pressure.

2. The method recited in claim 1, further comprising:
assessing the hollow fibre membrane as free of defects if the final gas pressure deviates from the starting gas by a value less than a predetermined differential pressure; and
assessing the hollow fibre membrane as defective if the final gas pressure deviates from the starting gas pressure by a value equal to or greater than the predetermined differential pressure.

3. The method recited in claim 1, wherein the second point in time is after the first point in time by a predetermined length of time.

4. The method recited in claim 2, wherein the second point in time is after the first point in time by a predetermined length of time.

5. The method recited in claim 1, wherein the starting gas pressure is less than a gas bubble pressure.

6. The method recited in claim 2, wherein the starting gas pressure is less than a gas bubble pressure.

7. The method recited in claim 3, wherein the starting gas pressure is less than a gas bubble pressure.

8. The method recited in claim 4, wherein the starting gas pressure is less than a gas bubble pressure.

9. The method recited in claim 1, wherein the gas is free of oxygen, nitrogen and hydrogen.

10. The method recited in claim 2, wherein the gas is free of oxygen, nitrogen and hydrogen.

11. The method recited in claim 3, wherein the gas is free of oxygen, nitrogen and hydrogen.

12. The method recited in claim 5, wherein the gas is free of oxygen, nitrogen and hydrogen.

13. The method recited in claim 1, wherein the gas is carbon dioxide.

14. The method recited in claim 2, wherein the gas is carbon dioxide.

15. The method recited in claim 3, wherein the gas is carbon dioxide.

16. The method recited in claim 8, wherein the gas is carbon dioxide.

17. The method recited in claim 1, wherein the hollow fibres are configured for ultrafiltration.

18. The method recited in claim 2, wherein the hollow fibres are configured for ultrafiltration.

19. The method recited in claim 16, wherein the hollow fibres are configured for ultrafiltration.
